(19) United States
(12) Patent Application Publication
(10) Pub. No.: US 2020/0181865 A1
(43) Pub. Date: Jun. 11, 2020

(54) CAISSON REPAIR METHOD AND APPARATUS

(71) Applicant: Ecosse Global UK Ltd., Dundee (GB)

(72) Inventor: Ernest COUTTS, Dundee (GB)

(73) Assignee: Ecosse Global UK Ltd, Dundee (GB)

(21) Appl. No.: 16/313,590

(22) PCT Filed: Jun. 29, 2017
(86) PCT No.: PCT/GB2017/051899

§ 371 Date: Dec. 27, 2018

(30) Foreign Application Priority Data
Jun. 29, 2016 (GB) 1611307.8

(51) Int. Cl. E02D 23/02; F16L 55/165

(52) U.S. Cl. CPC E02D 23/02; F16L 55/1654; F16L 55/1656

(57) ABSTRACT

The disclosure provides novel means and methods for the repair of water caissons in situ, for example at sea. The method generally includes providing a woven composite sock inside the caisson. The method further includes inserting a calibration tube into the composite sock within the caisson. The calibration tube can be filled with a pressurised fluid, preferably water, to pressurise the sock against the internal walls of the caisson. The sock can be infused with an epoxy resin. The resin is preferably water-curable. The composite sock can be allowed to cure with the calibration tube in place. The calibration tube can apply pressure to press the composite sock against the inner wall of the caisson. Once the composite matrix has cured to form a cured composite liner for the caisson, the calibration tube can be removed.

### FIELD OF THE INVENTION

The present invention relates to the reinforcement and/or repair of a wall of a hollow tubular member. In particular, the invention relates to the repair of vertical tubular caissons, particularly in the oil and gas industry, and of tubular members in other sectors.

### BACKGROUND OF THE INVENTION

In Oil & Gas production equipment such as oil and gas production rigs, sea water caissons are commonly used on production rigs to enable sea water to be drawn from below the surface of the surrounding sea and pumped up to deck level for use on the platform, in uses such as the cooling of production equipment and fire suppression, for example.

Seawater caissons are typically made from steel and, inevitably, in spite of the use of sacrificial anodes and treatments, the caisson will, over time, corrode due to contact with sea water. Such corrosion can result in thinning of the caisson walls, resulting in weakening of the caisson structure, and ultimately in perforation of the caisson wall. In severe cases, the caisson wall may fail completely and parts of the caisson or equipment attached to it can become detached. Repair of the caisson during its working life is therefore often necessary. Known repair methods exist, which include affixing a new steel tube within the caisson and swaging it into place in the caisson. Such methods can be effective in the short to medium term, but do still result in a metallic structure in sea water, which continues to be vulnerable to corrosion over its life.

There is also a need for pipe strengthening in other sectors, such as utilities, including gas and water supply lines, where existing pipe repair methods are either expensive, difficult to implement, or could otherwise be improved upon.

### SUMMARY OF THE INVENTION

The present invention provides novel means and methods for the repair of water caissons in situ, for example at sea. The method generally includes providing a woven sock inside the caisson. The sock is preferably made from e-glass. E-glass is most commonly alumino-borosilicate glass with less than 1% w/w alkali oxides, and is often used for glass-reinforced plastics. The method further includes inserting a calibration tube into the sock within the caisson. The calibration tube can be filled with a pressurised fluid, preferably water, to pressurise the sock against the internal walls of the caisson. The sock can be infused with a matrix such as an epoxy resin. The matrix, such as epoxy resin, is preferably water-curable. The matrix can be allowed to cure with the calibration tube in place. The calibration tube can apply pressure to press the sock against the inner wall of the caisson. Once the matrix has cured to form a cured composite liner for the caisson, the calibration tube can be removed.

The methods and apparatus used for the invention have a number of advantages over known methods. The use of a composite liner leaves no further metallic materials in place in the water caisson and so the new liner is not vulnerable to corrosion. Composite materials are relatively light and so add a relatively low additional weight to the caisson, reducing additional stress on and around any mounts for the caisson.

According to a first aspect of the present invention, a method of lining a water caisson offshore is provided, the method comprising the steps of:
a) providing a woven sock having an outer diameter when expanded radially which is substantially equal to the inner diameter of the caisson;
b) providing a matrix to the sock to form a fibre-matrix composite;
c) locating the sock and the matrix inside the bore of the caisson;
d) providing expansion means inside the sock, the expansion means being configured to radially expand a length of the sock within the caisson;
e) retaining the sock in compression against an inner wall of the caisson via the expansion means during curing of the matrix; and
f) after curing of the matrix, removing the expansion means to leave the sock and matrix in place as a composite liner for the water caisson.

The sock and matrix combination may be cured at least partially below the surface of the water. The matrix may be a water-curable matrix, capable of curing under water. For example, the matrix may be an epoxy resin.

The sock may also be configured such that its outer diameter cannot exceed a diameter substantially equal to the inner diameter of the caisson.

The expansion means may comprise an inflatable tube, wherein the inflatable tube may be inflated with a pressurised fluid, and wherein the fluid may be provided via an opening in the tube located adjacent an upper end of the caisson.

The pressurised fluid may be a liquid, wherein the fluid in the tube is pressurised by weight of the fluid inside the tube. The liquid may be pressurised by a head of the fluid, preferably water, the head being greater than 0.1 m above an upper end of the part of the sock being installed in the caisson. Optionally, the head may be greater than 0.5 m, preferably greater than 0.8 m.

Additionally, the woven sock may comprise e-glass.

According to a further aspect of the present invention, a water caisson is provided, the water caisson comprising a metallic outer shell, and a composite liner comprising a woven sock provided with a cured composite matrix.

The cured matrix may comprise a water-curable epoxy resin, and the composite liner may be adhered to the outer shell by the cured matrix.

In a further aspect of the present invention, a method of strengthening a hollow member such as a pipe is provided, comprising the steps of:
a) providing a woven sock having an outer diameter when expanded radially which is substantially equal to the inner diameter of the pipe;
b) providing a matrix to the sock to form a fibre-matrix composite;
c) locating the sock and matrix inside the bore of the pipe;
d) providing expansion means inside the sock, the expansion means being configured to radially expand a length of the sock within the pipe;
d) retaining the sock in compression against an inner wall of the pipe via the expansion means during curing of the matrix; and
e) after curing of the matrix, removing the expansion means to leave the sock and matrix in place as a composite liner for the pipe.

The matrix provided to the sock may be cured underwater. The sock may also be configured such that its outer diameter cannot exceed a diameter substantially equal to the inner diameter of the pipe. The sock may have a diameter at rest and may be capable of expanding to twice that diameter when expanded.

The matrix may be a water-curable resin, capable of curing under water, for example, the matrix may be an epoxy resin.

The matrix may be one which cures at an ambient temperature of between around 0 degrees centigrade to around 40 degrees centigrade, without requiring further heat input for curing. The matrix may be one which cures at an ambient temperature of between around 5 to 20 degrees centigrade, 5 to 10 degrees centigrade, or any integer value, or sub-range of integer values, within those ranges. The matrix preferably has a gel time of between 3 hours to 8 hours at an ambient temperature of 5 degrees centigrade. Preferred gel times are in the range of 6 to 8 hours, preferably around 7 hours+/−half an hour. The matrix may be one which cures requiring no active thermal input to trigger curing. The matrix may be one which cures by exothermic reaction.

In some implementations, the expansion means may be a flexible tube capable of holding a fluid. The method may further comprise providing water to an upper end of the expansion means to drive water out of a lower end of the caisson by driving a lower wall of the expansion means down into the caisson by force of gravity. Pressure provided in the expansion means by weight of the water provided into the expansion means may retain the sock in compression against the inner wall of the caisson below the surface of the surrounding water during curing of the matrix. The same may be applied for any pipe or tubular vessel to which the method is applied, not only water caissons.

The expansion means may comprise an inflatable tube, wherein the inflatable tube may be inflated with a pressurised fluid. Such fluid may be provided via an opening in the tube located adjacent an inlet end of the pipe.

The fluid may be a liquid pressurised by weight of the liquid in the tube, wherein the liquid may be pressurised by a head of the liquid, the head being greater than 0.1 m above an upper end of the part of the sock being installed in the caisson. Optionally, the head may be greater than 0.5 m, preferably greater than 0.8 m.

Alternatively, the fluid may be a pressurised gas.

The expansion means may comprise a flexible-walled tubular member, wherein the tubular member may have a longitudinal axis, an outer tube wall extending longitudinally to the axis, and an inner wall extending longitudinally to the axis to form a fluid enclosure between the inner and outer tube walls. The outer wall and the inner wall may be formed from the same tubular piece of material.

The tubular member may also comprise a bottom wall extending between the outer wall and the inner wall, wherein the bottom wall may be formed from the same tubular piece of material as the inner and outer tube walls. The material may be a flexible, woven material which is substantially fluid-tight. For example, sail material suitable for manufacturing sails of a sailing boat can be employed.

An air way may be provided passing internally to the tubular member, from a first end of the tubular member to a second end of the tubular member, the airway being separated from a fluid enclosure provided in the tubular member. The airway may act to allow air trapped between the expansion means and a second end of the caisson or hollow member being lined, the second end being distal from a first end of the caisson or hollow member, via which the expansion means is being deployed. The second end may be under water.

The expansion means may be deployed without longitudinal translation of the walls of the tube relative to the sock.

The expansion means may also be deployed by fluid pressure provided inside the expansion means.

According to a further aspect of the present invention, a pipe is provided comprising a metallic shell, and a composite liner for the shell, disposed within the shell and comprising a woven sock provided with a cured matrix.

The composite liner may be adhered to the outer shell by the cured resin.

The invention can provide a tubular member comprising a metallic shell and a composite liner inside the shell, the liner comprising a combination of reinforcement fibres and epoxy resin, which is substantially bonded or adhered to the inner wall of the caisson by the matrix.

The sock and/or the liner may comprise Kevlar and/or Technora and/or Twaron™. Kevlar is a well-known brand of fibre manufactured by DuPont and comprises, in its base form, aramid fibres comprising poly-paraphenylene terephthalamide, as will be understood by the person skilled in the art of such fibres. The sock and/or the liner may comprise aramid fibres and/or para-aramid fibres. The fibres of the sock and/or liner may comprise E-glass and/or Kevlar and/or Technora and/or Twaron™.

The weave type of the sock material may be a uni-directional weave.

### BRIEF DESCRIPTION OF THE DRAWINGS

Embodiments of the invention will now be described with reference to the accompanying drawings, in which:

FIGS. 1A to 1E illustrate steps in a method of lining a caisson according to an embodiment of the invention.

FIGS. 2A and 2B illustrate equipment and method steps suitable for installing the sock and/or calibration tube in certain embodiments of the invention.

### DETAILED DESCRIPTION OF EMBODIMENT(S)

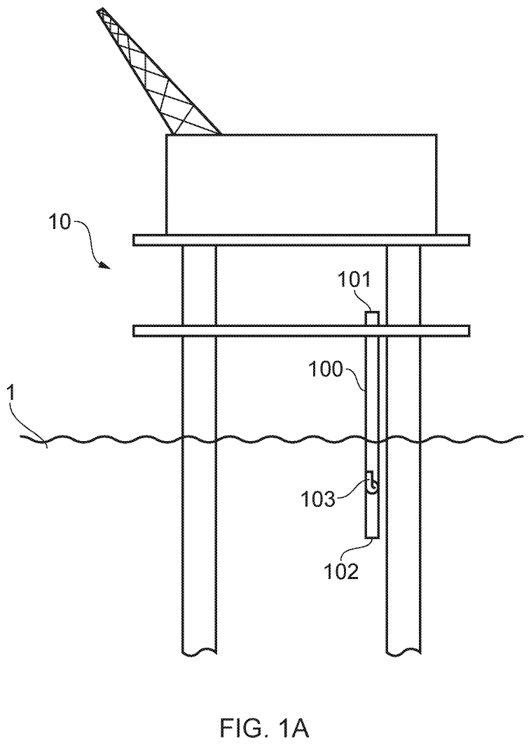

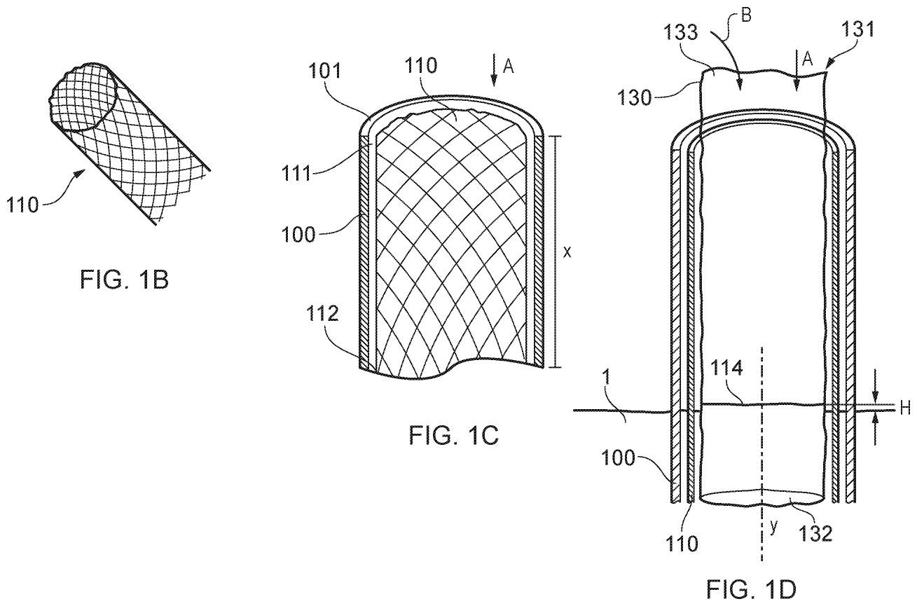

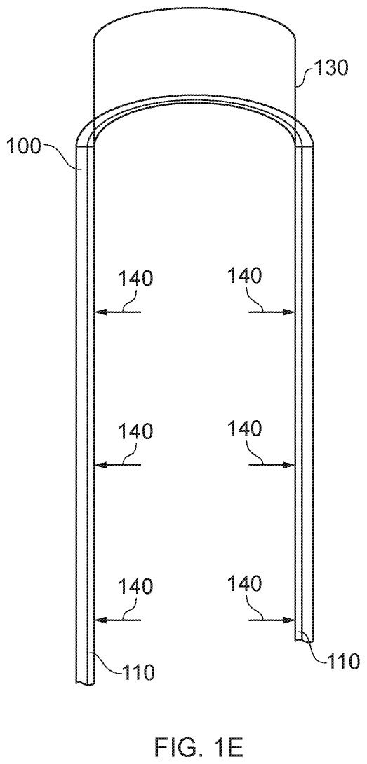

FIG. 1A shows a sea water caisson 100 in situ on an offshore structure 10. The structure may be an oil or gas production rig, or any other offshore structure. Such offshore structures may be at sea or may also be in an inland body of water, such as a river or lake. The structure is at sea and the sea water caisson extends from a first open end 101 at a first location, at deck level of the rig 10, to a point 102 below the surface of the water 1. A pump 103 may be located in the caisson during normal operations and this may be removed for the repair or maintenance of the caisson 100. These caissons are often used at sea in oil or gas production structures, but can be used in any application where it is desired to bring water from the water's surface below to a desk level of a structure or vessel.

FIG. 1B shows a woven sock 20 for use with the present invention. The sock 110 is woven as a substantially elongate tubular weave. Such socks can be generally formed from woven fibres and are used in a number of applications in other technical areas. Generally, composite tubes can be manufactured to replace any structural member previously made from another solid material, such as metals. Composite structures have a generally good strength to weight ratio, although they can come at an elevated cost when compared to their metal counterparts, due to the cost of materials and the practicalities of manufacturing processes. Such tubular composite members have generally in the past been manufactured in bulk manufacturing processes and cut to length or shape afterwards and then incorporated into assemblies or structures by standard cutting and affixation techniques, as would be the case with standard metallic tubular components.

Composite materials generally comprise reinforcements in the form of fibres, such as glass fibres or carbon fibres. The fibres are then generally combined with a matrix, which acts to bind the fibres together into a solid body. One of the oldest forms of such a structure is glass fibre, which has been used in the fabrication of, for example, marine vessels for many years. More recently, the use of carbon fibres has become more popular due to their superior strength, although their cost is generally greater than glass fibres. The woven tubular sock 110 illustrated in FIG. 1B can therefore act as the reinforcement part of a composite liner formed in a water or seawater caisson in the case of the present invention. Sock 110 can be woven from any form of fibres, but preferably from carbon fibres. Any known form of fibre weave for forming a tube can be used. However, preferably, the weave is formed so as to prevent the overall diameter of the sock from exceeding its maximum design diameter. In the present implementation, this acts to prevent the sock from “bulging out” through any perforation or thinned section in the seawater caisson being lined by the sock.

To obtain a composite liner for a seawater caisson from the sock 110, it is necessary to provide a matrix to the sock 110. A range of known composite matrices are available, including organic matrices such as polymers, including polyester, vinylester resin or epoxies. The matrix can be applied to the sock 110 in any known way in the present methods. In preferred methods, the liner is simply passed through a volume of resin to ensure that the fibres of the sock are fully wetted-out. Other known methods of wetting out the sock may be used and will be described in more detail later in the specification. Once the matrix has been applied, the wetted sock 110 may be inspected at an inspection station such as an inspection table, to ensure that the matrix has correctly wetted-out the sock.

FIG. 1C illustrates the initial location of the sock 110 within the caisson 100. The sock 110 is generally inserted into the caisson through an upper open end 101 of the caisson 100. Since the caisson is generally substantially vertically installed, gravity acting in a downward direction, as illustrated by arrow A of FIG. 1C, will generally allow the sock to be drawn into the caisson 100 by force of gravity. A suitable chosen length X of sock 110 is located within the caisson 100. The sock 110 is thus inserted into the caisson 100 and extends over a length X from a first point 111 on the caisson length to a second point 112, the length X covering the region of the caisson to be lined.

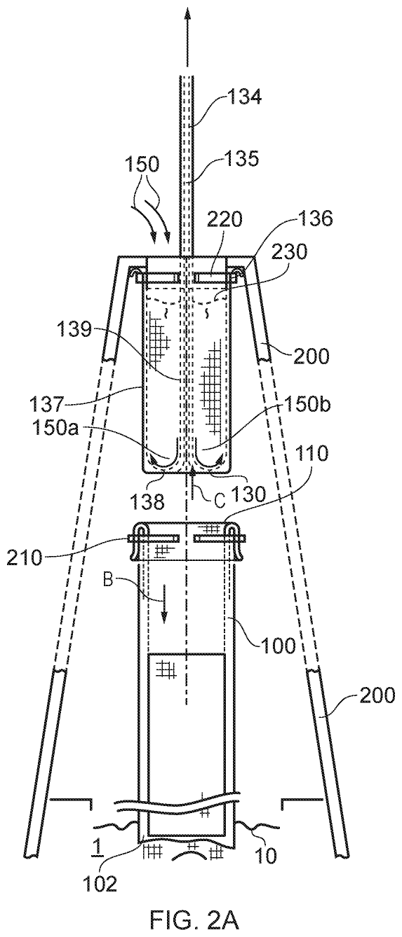

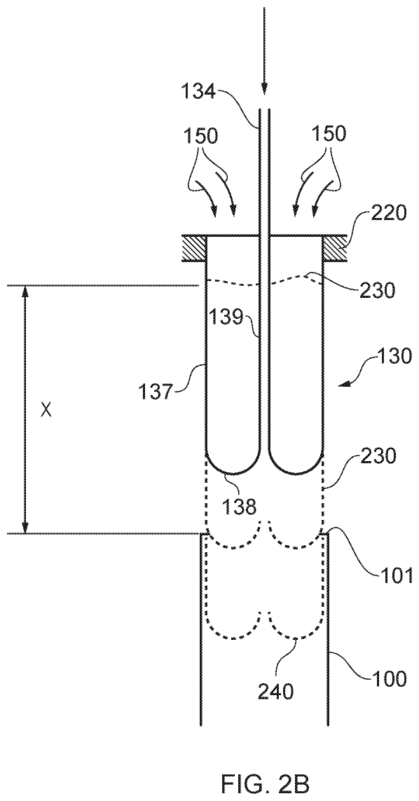

FIG. 1D illustrates an insertion of an expansion means 130 into the sock 110 within the caisson 100. The sock 110 is retained at the desired vertical position in the caisson, that is, at a desired position along a longitudinal axis Y of the caisson, as is illustrated in more detail in relation to later FIG. 2A.

The expansion means could take a variety of forms, but in the present case is provided in the form of a flexible tube 130, which has a closed end 132 provided toward the bottom of the tube during installation, and an open end 133 is provided at an upper end 131 of the expansion tube 130. The expansion tube 130 may be termed a “calibration tube”. The general function of the expansion means is to provide a substantially uniform outward pressure on the inner walls of the sock 110 in order to adhere it to the inner walls of the caisson once the matrix has cured. Force of gravity acting in a direction of arrow A in Figure D can be employed to draw the calibration tube 130 into the interior bore of the sock 110, until the desired position is reached. A liquid such as water, may also be introduced into an opening in the calibration tube as illustrated by arrow B. As such water is introduced, the weight of the water within the calibration tube 130 will increase, increasing the downward force in the direction of arrow A. Once the closed end 132 of the calibration tube reaches the surface of the water 1, which is also present within the caisson 100, any distance by which the water's surface 114 within the calibration tube 130 is higher than the surface of the water 1 (shown as distance H in the figure), will cause a net downward force in the direction of arrow A, and also an outward radial pressure perpendicular to axis Y of the caisson 100 on the inner walls of the tube 130. This outward force is transferred by the flexible walls of the tube to the press the sock 110 against the inner walls of the caisson 100.

Once the calibration tube 130 has reached its desired longitudinal position along the longitudinal axis Y of the caisson 100, then it is held in position. This can be done as described in relation to FIGS. 2A and 2B.

In order to effectively drive the composite sock 110 and its matrix in an outward direction perpendicular to axis Y of the caisson 100, it is necessary to provide a sufficient amount of pressure within the calibration tube 130. It has been found that an effective means or providing such pressure is by providing a head of water within the calibration tube 130, which provides a suitable uniform pressure expanding the calibration tube outwardly against the walls of the caisson 100. This causes the calibration tube 130 and the sock 110 to be biased outwardly against the inner walls of the caisson 100. It has been found that a suitable head of water to be provided above the caisson entry, i.e. the upper open end 101 of the caisson. This can be achieved as shown in relation to FIGS. 2A and 2B.

The method can also be effectively carried out by providing any suitable head above around 0.1 metres, while other figures such as 0.5 metres, 0.6 metres, 0.7, 0.8, 0.9, 1 metre, 2 metres, 3 metres or more, can all be usefully implemented, along with any range of values within that disclosed set of values. In this way, a suitable outward pressure in the direction of arrow 140 can be provided, as shown in FIG. 1E.

Once this pressure is in place, the sock 110 is driven outwardly against the inner walls of the caisson 100 and this pressure can be maintained in place through the curing time of the matrix for the composite liner. Such curing times are typically in the range of 24 to 48 hours.

As will be appreciated from FIG. 1D in particular, at least a portion of the sock and its matrix may be below the surface of the water 1 and so it can be desirable to have a matrix, such as an epoxy resin, for the sock which is capable of curing under water.

By using the methods in accordance with those described above, it is possible to provide tubular member having a composite liner, comprising a combination of reinforcement fibres and epoxy resin, which is substantially bonded or adhered to the inner wall of the caisson by the matrix. This can substantially prevent any further significant corrosion of the inner wall of the seawater caisson and can provide additional strength to the overall structure of the caisson throughout the whole length over which the composite liner is provided.

FIG. 2A illustrates further detail of an apparatus and related method steps which can be employed in the deployment of the sock and calibration tube in the present invention. FIG. 2A illustrates an upper end 101 of a caisson 100 at a deck level of a structure at sea. The caisson 100 extends from its open upper end 101 down to an open lower end 102 below the surface 10 of the body of water 1. As illustrated, the sock 110 is installed within the caisson 100. This installation process can be manual, for example by one or more users bringing the sock to the caisson and deploying it gradually into the tube, for example with the assistance of gravity. In some examples it could be drawn into the caisson actively by pulling from below. The sock 110 is then clamped in place at the open end of the caisson by clamping means 210. This may be a simple ring-type clamp. The clamp 210 is generally configured to apply a substantially radial force to the sock 110 to clamp the sock in place on the caisson 100. The sock then extends in a downward direction, as illustrated by arrow B, and is located in place to extend over the area to be lined. This may be the full length of the caisson 100 from its top end 101 to its bottom end 102. Alternatively, a sub-section of the overall length of the caisson 100 may be lined with sock 110 in order to line, strengthen or repair one or more sub-sections of its length.

An overhead structure 200 can be used to suspend the calibration tube 130 in place above the caisson 100. In the illustrated example, the structure 200 is a tripod-like structure, supported upon the deck surrounding the caisson 100. However, it could be supported in any way, for example from the underside of a deck above the caisson 100, or a ceiling above the caisson 100, for example. In the illustrated example, the first open end 136 of the calibration tube 130 can be clamped to the support structure 200 in order to hold the open end 136 of the calibration tube 130 open and substantially aligned above the caisson 100. Clamping means 220 can be provided for this function and can be configured to provide a substantially radial clamping force to clamp the sock in place. Other forms of fixing means or clamping means can be used. The calibration tube 130 can be lowered into the caisson 100 in a number of ways. In the illustrated example, the calibration tube comprises a wall 137 which forms the outer side of the calibration tube. The wall 137 can, as illustrated, also return radially inward, to form a bottom wall 138 of the calibration tube. As further illustrated, the same wall 138 form a bend and extend longitudinally within the outer wall 137 of the calibration tube. This longitudinal extension forms a radially inner wall 139 for the calibration tube. As illustrated, the calibration tube can therefore comprise an outer bore formed by its outer wall 137 and an inner bore 135 formed by the radially inner wall 139, which may be separated by a bottom wall 138 of the calibration tube. As shown above, the bottom wall 138 can be integrally formed as the same component or from the same material, as the inner and/or outer walls 137 and 139. The inner bore 135 can provide an airway to allow air to pass through the calibration tube in a direction of arrow C, from the surface of the water within the caisson to escape via its open end 101. An airway 135 can therefore be provided in the calibration tube in order to allow air to pass from a bottom end of the calibration tube to an upper end of the calibration tube. This can enable any air which is trapped below the calibration tube 130 in the caisson 100 during the installation procedure to escape the caisson 100 and to pass up the inner bore 134 in the calibration tube, to escape to atmosphere.

Further, by lowering the walls 139 of the inner bore 134 of the calibration tube 130 downwardly in a direction of arrow B, the inner wall 139 can “unfurl” to become the lower wall 138 and subsequently the outer wall 137 as the tube is further unfurled. The calibration tube 130 can be gradually extended into the caisson 100 as the walls unfurl in a direction of arrows 150a and 150b. The inner bore 134 of the calibration tube 130 can be affixed to an overhead crane or other lifting means above the caisson 100 to raise or lower the calibration tube 130 into or out of the caisson 100.

Before being lowered into the caisson 100, the calibration tube 130 can be filled with a first amount of water, for example up to the water level 230 indicated in the figure. This provides downward weight in order to encourage the calibration tube 130 into the bore of the caisson 100. This weight can also encourage the inner bore 134 to be drawn downward into the calibration tube 130, and to “unfurl” radially in an outward direction as shown by arrows 150a and 150b. As described above, this allows the inner bore of the calibration tube to form the outer wall 137 of the calibration tube, as the wall 139 of the inner bore 134 is lowered into the caisson 100.

FIG. 2B provides a further schematic illustration of how the calibration tube 130 is progressively extended into the caisson 100, as its lower profile sequentially occupies the positions illustrated by dashed lines 230 and 240. As will be appreciated, as the lower end wall 138 descends toward and into the caisson 100, in the absence of further water being added, the water level 230 will also descend downwardly into the caisson 100. If the water level 230 is at the same level as the surface of the water around the caisson, no head is provided. However, the head of fluid X required to provide the necessary pressure against the sock 110 within the caisson 100 can be maintained by providing additional fluid into the calibration tube 130, as illustrated by arrow 150. This can provide a means of deploying the calibration tube into the caisson without any longitudinal translation of the walls of the calibration tube relative to the sock 110.

The fluid added to the calibration tube generally acts to compress the sock 110 against the inner walls of the caisson during curing of the matrix. The fluid provides sufficient pressure to extend the calibration tube 130 into the caisson 100. The fluid may further be required to provide sufficient pressure to drive water out of the bottom of the caisson in situations where the lining of the caisson occurs under water.

As described above, once fully deployed over some or all of the length of the sock 110, the calibration tube 130 can be left in place for the necessary curing time of the matrix or epoxy resin. This is generally in the order of 24-48 hours. Once the curing is complete, the calibration tube can be withdrawn, which is substantially the reverse of the installation process, i.e., the inner bore 134 can be withdrawn out of the open end 101 of the caisson by its walls. This can progressively remove the calibration tube from the caisson, peeling the tube from the outer walls. This removal can be done by raising the inner bore walls by an overhead lifting device such as a crane. At the same time water is removed from the interior of the calibration tube 130, since the volume within the calibration tube reduces as the lower wall 138 rises. This water may be pumped out, but may alternatively simply be allowed to spill over the top of the calibration tube 130 and to run away if that is practically convenient in the installation environment in question. The removal of water from the calibration tube may therefore be active or merely passive, by the driving out of the water by the rising of the bottom wall 138.

As will be appreciated, the calibration tube 130 may be re-used for repeated installations and provides a practical and convenient method for installing the composite liner and holding it in place during curing, while requiring minimal overhead installation space and also requiring a minimum of installation equipment, which renders the process more efficient and cost-effective when compared to prior art methods for repairing water caissons, in particular in situ in an offshore installation.

The above examples are described in relation to the repair of water caisson in situ. However, it will be appreciated that the method and apparatus can be applied to other forms of vessel required to be lined with a composite lining. The tube lining and composite sock installation procedure described herein can be implemented in other practical settings. Any substantially vertical tubular member, which has at least some downward extension along its length can have the sock and calibration tube installed by virtue of the methods described herein. Other variations may be considered. For example, sock 110 may be combined with the calibration tube 130, prior to insertion of either item into the caisson or tubular member to be repaired. For example, the sock could be substantially mated with the wall 137, 138 and 139 of the calibration tube and both sock and calibration tube deployed into a pipe or caisson 100 simultaneously.

Further, although the main examples described herein use water to provide the necessary pressure to extend the calibration tube 130 along the item to be repaired and to provide outward pressure against its inner walls, other forms of pressurised fluid may be employed, for example liquid or gas provided under pressure from a pressurising means, such as a pump or other pressurised fluid source.

In some implementations, the pipe or tube to be repaired may be substantially horizontally extending, or may extend upwardly along its length by provision of suitable pressure inside the calibration tube 130, the calibration tube could also be deployed in horizontal or upward directions in order to install the sock and calibration tube, and to retain them in place during curing of the matrix or epoxy resin.

Such other implementations for the current methods include repair, strengthening, or lining for these and any other reasons, of any pipe or tubular member. Examples include such as pipework used in utilities, oil or gas distribution pipework, other land-based utilities, such as those carrying out transport or treatment of water or sewage. Indeed any other substantially hollow body which may benefit from being lined with a woven composite liner may benefit from the methods and apparatus described herein.

For the implementation of the present invention, it has generally been found that use of an epoxy that is able to cure under water, but which has a suitable viscosity to wet out the fabric being used, permits implementation of the desired curing below the surface of the water which provides some of the benefits of the methods described herein. Preferred viscosity values for a matrix for use in these implementations are from a round 1.5 mPa·s to 3.5 mPa·s. Preferred ranges include from around 2.8 to 3.2 mPa·s, with a preferred value being 3 mPa·s. 1 cP=10⁻³ Pa·=1 mPa·s, so these same values apply in cP as well.

The matrix may be one which cures at an ambient temperature of between around 0 degrees centigrade to around 40 degrees centigrade, without requiring further heat input for curing. The matrix may be one which cures at an ambient temperature of between around 5 to 20 degrees centigrade, 5 to 10 degrees centigrade, or any integer value, or sub-range of integer values, within those ranges. The matrix preferably has a gel time of between 3 hours to 8 hours at an ambient temperature of 5 degrees centigrade. Preferred gel times are in the range of 6 to 8 hours, preferably around 7 hours+/−half an hour. The matrix may be one which cures requiring no active thermal input to trigger curing. The matrix may be one which cures by exothermic reaction.

It has been found that a particularly beneficial composition of the sock material can include materials known as Kevlar™ and/or Technora™ and/or Twaron.

Kevlar is a well-known brand of fibre manufactured by DuPont and comprises, in its base form, aramid fibres comprising poly-paraphenylene terephthalamide, as will be well known to the person skilled in the art of such fibres. An early publication relating to Kevlar technology is U.S. Pat. No. 3,287,323. The definitions of the fibres therein can be directly applied to the present teachings to assist in carrying out embodiments of the present invention but are not reproduced herein in full as their manufacture and resulting properties will be readily understood by the person skilled in the technical area of composite fibres.

Technora™ is also a material which can improve the performance of composite materials. Technora is a para-aramid fibre, comprising Diaminodiphenylether-para-phenylenediamine-terephthaloyldichloride. It is produced by condensation polymerization of terephthaloyl chloride (TCl) with a mixture of p-phenylenediamine (PPD) and 3,4′-diaminodiphenylether (3,4′-ODA).

Twaron™ is a p-phenylene terephthalamide, which can be abbreviated to (PpPTA). PpPTA is commonly understood to be a product of p-phenylene diamine (PPD) and terephthaloyl dichloride (TDC). To dissolve the aromatic polymer Twaron uses a co-solvent of N-methyl pyrrolidone (NMP) and an ionic component (calcium chloride CaCl2) to occupy the hydrogen bonds of the amide groups.

The sock may comprise a plurality of layers of woven fabric. Preferred specifications of the fabric or at least one of its layers are a follows.

Mass per unit area of the fabric is preferably of around 170 g/m² to 800 g/m², with a preferred range being around 550 g/m² to 600 g/m², all values being +/−10%.

The weave type may be plain, cross directional, bi-axial or tri-axial, and a preferred weave type is uni-directional.

The material can in some implementations be a pure e-glass weave. However it is considered that preferred materials will include a proportion of a strengthening fibre. The strengthening fibres may be any of the Kevlar, Technora or Twaron fibre types discussed above, or aramid or para-aramid fibres.

The woven material of the sock may comprise between around 20% to 80% strengthening fibres, with the remainder of its fibres being e-glass. E-glass is typically alumino-borosilicate glass with less than 1% w/w alkali oxides. Optional values for the proportion of strengthening fibres are 25%, or between 20% to 30%, between 20% to 40%, or between 20% to 80%.

A preferred ratio of matrix to fibres in the completed material is around 6:4 (or 60:40).

Typically the thickness of the composite liner resulting from the methods will be in the range of 4 mm to 8 mm. This may vary depending upon the number of layers of woven material used in the woven sock.

The fibres use may have a mass in grams per 10,000 meters of around 100 to 3000 dtex. Thread count of the fabric may be between 1 and 20 ends/cm, preferably between 4 to 12 ends/cm.

Comparative tests were carried out on different materials provided in the woven sock and the results and procedure were as follows. The tensile strength of the material was determined using ASTM D 3039/ISO 527-4.

Sample Preparation

The material system tested consists of a Kevlar and glass fibre tape and a two part water-curable Epoxy Matrix. The Epoxy resin used is commercially available from Piping Repair Technologies (PRT) (pipingrepairtechnologies.com) under the brand name X100.

The tape used in the test was a woven tape comprising 50% aramid Twaron by weight, with a dtex value of 2200-120 in both warps and wefts. The remaining 50% weight was E-glass. The mass per unit area of the fabric was 170 g/m², with a plain weave.

Panels of the fabric tape were cut from a sample roll. Each panel was then placed on top of a sheet of vacuum bagging plastic and a boundary of tacky tape placed around the panel. The resin was thoroughly mixed in a 100:60 ratio of base to curing agent which was then poured above and below the woven glass/Kevlar panel. Another sheet of bagging plastic was placed on top of the glass panel and the edges sealed to the tacky tape. A roller was used to aid in the wetting out of the fabric. Once the fabric was sufficiently saturated, a 155 kg weight equivalent to 0.1 Bar of pressure was placed over the panel, which was then left for 24 hours to consolidate and cure. Once the panels were sufficiently cured, the weight was removed and the panel placed in an oven at 50 C to speed up the final portion of the cure. Samples were rectangular, 25 mm×250 mm with a thickness determined by the fabric thickness and fibre to resin ratio of approximately 4.75 mm. The samples were cut using a table saw.

Test Method

Tensile tests were carried out according to ASTM D3039/ISO 527-4. Five tensile specimens were tested at a crosshead speed of 2 mm/min. The samples were tabbed using a 120 grit emery paper which was cut into 25 mm² squares, the squares were placed between the jaws and the samples, covering the entire gripping area, with the grit side facing the sample. Sample slippage was checked by stopping the first test before failure and measuring the area of the sample within the jaws.

Results

Results for the 5 samples including the Kevlar material, and their average can be found in table 1 below.

TABLE 1
Tensile test results

| | | Ultimate tensile | |
|---|---|---|---|
| Sample | Modulus (MPa) | strength (MPa) | Time to break (s) |
| 1 | 8042.91 | 235.25 | 335.5 |
| 2 | 7768.23 | 229.92 | 351.0 |
| 3 | 7292.71 | 199.02 | 333.3 |
| 4 | 7333.80 | 204.8 | 306.2 |
| 5 | 6750.81 | 183.88 | 280.0 |
| Average | 7438.69 | 210.57 | 321.2 |

The extension of the samples at failure was minimum, with the main mode of failure being fibre failure.

The same tests were also carried out without the Kevlar material present in the woven e-glass material, i.e. with a pure e-glass fabric for the woven material, and comparisons of the two fabrics that have been tested are shown in Table 2 below.

TABLE 2
Comparative tensile test results

| | Kevlar | Knitted Glass |
|---|---|---|
| Young's Modulus (MPa) | 7438.69 | 1864.58 |
| Ultimate Tensile Strength (MPa) | 210.57 | 76.65 |
| Elongation at break (mm) | 11.25 | 22.5 |

As can be seen, the inclusion of the Kevlar materials significantly improves the performance, providing approximately 4 times the Young's Modulus. Ultimate Tensile Strength is around 2.75 times higher for the material including Kevlar. As can also be seen, elongation at break is half for the material including Kevlar compared to the material including only the E-glass fibres.

Although the invention has been described above with reference to one or more preferred embodiments, it will be appreciated that various changes or modifications may be made without departing from the scope of the invention as defined in the appended claims.

1. A method of lining a water caisson offshore, comprising the steps of:
a) providing a woven sock having an outer diameter when expanded radially which is substantially equal to the inner diameter of the caisson;
b) providing a matrix to the sock to form a fibre-matrix composite;
c) locating the sock and the matrix inside the bore of the caisson;
d) providing expansion means inside the sock, the expansion means being configured to radially expand a length of the sock within the caisson;
e) retaining the sock in compression against an inner wall of the caisson via the expansion means during curing of the matrix; and
f) after curing of the composite matrix, removing the expansion means to leave the sock and composite matrix in place as a composite liner for the water caisson.

2. The method of claim 1, wherein the sock and matrix line the caisson at least partially below the surrounding water and are cured at least partially below the surface of the surrounding water.

3. The method of claim 1, wherein the matrix is a water-curable matrix, capable of curing under water.

4. The method of claim 1, wherein the sock is configured such that its outer diameter cannot exceed a diameter substantially equal to the inner diameter of the caisson.

5. The method of claim 1, wherein the matrix is at least one of: an epoxy resin;
one which cures without requiring heat input for curing;
one which cures by exothermic reaction.

6. (canceled)

7. (canceled)

8. The method of claim 1, wherein: the expansion means is a flexible tube capable of holding a fluid; the method further comprising providing water to an upper end of the expansion means to drive water out of a lower end of the caisson by driving a lower wall of the expansion means down into the caisson by force of gravity; and
wherein pressure provided in the expansion means by weight of the water provided into the expansion means retains the sock in compression against the inner wall of the caisson below the surface of the surrounding water during curing of the matrix.

9. The method of claim 8, wherein the matrix is a water-curable composite matrix, capable of curing under water.

10. The method of claim 1, wherein the expansion means comprises an inflatable tube, optionally,
the inflatable tube is inflated with a pressurised fluid, optionally,
the fluid is provided via an opening in the tube located adjacent an upper end of the caisson.

11. (canceled)

12. (canceled)

13. The method of claim 10, wherein the pressurised fluid is a liquid.

14. The method of claim 13, wherein the fluid in the tube is pressurised by weight of the fluid inside the tube.

15. The method of claim 13, wherein the liquid is pressurised by a head of the fluid, the fluid preferably being water, the head being greater than 0.1 m above an upper end of the part of the sock being installed in the caisson.

16. The method of claim 15, wherein the head is greater than 0.5 m, or greater than 0.8 m.

17. The method of claim 1, wherein the woven sock comprises at least one of: e-glass;
aramid fibres;
para-aramid fibres;
Kevlar™;
Technora™;
Twaron™;
a uni-directional weave.

18.-21. (canceled)

22. A water caisson comprising:
a metallic outer shell;
a composite liner comprising a woven sock provided with a cured matrix.

23. A water caisson according to claim 22, wherein the cured matrix comprises a water-curable epoxy resin, and/or the composite liner is adhered to the outer shell by the cured matrix.

24. (canceled)

25. A method of strengthening a hollow member such as a pipe, comprising the steps of:
a) providing a woven sock having an outer diameter when expanded radially which is substantially equal to the inner diameter of the pipe;
b) providing a matrix to the sock to form a fibre-matrix composite;
c) locating the sock and matrix inside the bore of the pipe;
d) providing expansion means inside the sock, the expansion means being configured to radially expand a length of the sock within the pipe;
e) retaining the sock in compression against an inner wall of the pipe via the expansion means during curing of the matrix; and
f) after curing of the matrix, removing the expansion means to leave the sock and matrix in place as a composite liner for the pipe;
wherein the matrix provided to the sock is cured underwater.

26.-35. (canceled)

36. The method of claim 25, wherein the expansion means comprises a flexible-walled tubular member; optionally,
the tubular member has a longitudinal axis, an outer tube wall extending longitudinally to the axis, and an inner wall extending longitudinally to the axis to form a fluid enclosure between the inner and outer tube walls; optionally,
the outer wall and the inner wall are formed from the same tubular piece of material;
optionally,
the tubular member comprises a bottom wall extending between the outer wall and the inner wall; and optionally,
the bottom wall is formed from the same tubular piece of material as the inner and outer tube walls.

37.-40. (canceled)

41. The method of claim 36, wherein an air way is provided passing internally to the tubular member, from a first end of the tubular member to a second end of the tubular member, the airway being separated from a fluid enclosure provided in the tubular member.

42. The method of claim 41, wherein the airway acts to allow air trapped between the expansion means and a second end of the caisson or hollow member being lined, the second end being distal from a first end of the caisson or hollow member, via which the expansion means is being deployed.

43. A method according to claim 36 wherein the expansion means is deployed without longitudinal translation of the walls of the tube relative to the sock; optionally,
the expansion means is deployed by fluid pressure provided inside the expansion means.

44.-46. (canceled)
